(19) United States
(12) Patent Application Publication
(10) Pub. No.: US 2025/0229603 A1
(43) Pub. Date: Jul. 17, 2025

(54) DRIVING CONTROL APPARATUS FOR FLUID HEATER AND CONTROL METHOD THEREFOR

(71) Applicant: Hanon Systems, Daejeon (KR)

(72) Inventors: Yong Ha Chae, Daejeon (KR); Kil Sang Jang, Daejeon (KR)

(21) Appl. No.: 18/700,400

(22) PCT Filed: Dec. 9, 2022
(86) PCT No.: PCT/KR2022/020037

§ 371 Date: Apr. 11, 2024

(30) Foreign Application Priority Data
Dec. 14, 2021 (KR) 10-2021-0178713

(51) Int. Cl. B60H 1/22; B60H 1/00; H01M 10/615; H01M 10/625; H01M 10/633; H01M 10/6571

(52) U.S. Cl. CPC B60H 1/2218; B60H 1/00278; H01M 10/615; H01M 10/625; H01M 10/633; H01M 10/6571; H01M 2220/20

(57) ABSTRACT

Abstract: The present invention relates to a driving control apparatus of a fluid heater for controlling battery temperature and a control method therefor, and more particularly, to a driving control apparatus for a fluid heater and a control method therefor that are capable of maximizing the allowable voltage range while simultaneously ensuring the stability of the fluid heater in such a way as to satisfy peak current limit, maximum heater heating amount limit, and allowable maximum watt density by adjusting the connection configuration between the power supply and the first and second heating elements based on the voltage value supplied from the power supply unit.

### TECHNICAL FIELD

The present invention relates to a driving control apparatus for a fluid heater and a control method therefor, and more particularly, to a driving control apparatus for a fluid heater and a control method therefor that are capable of maximizing the allowable voltage range while simultaneously ensuring the stability of the fluid heater in such a way as to satisfy peak current limit, maximum heater heating amount limit, and allowable maximum watt density by adjusting the connection configuration between the power supply and the first and second heating elements based on the voltage value supplied from the power supply unit.

### BACKGROUND ART

The motor that drives the wheels of an electric vehicle is powered by the battery. The performance of batteries in electric vehicles is influenced by various factors, but it is particularly sensitive to temperature, causing the maximum current during battery charging and discharging to vary depending on the temperature.

In other words, the temperature of the battery varies based on the internal chemical reactions and the external environment, and for the efficiency of electric vehicle batteries, it is necessary to maintain the optimal temperature and mitigate temperature changes.

As a solution to this, Japanese Patent Publication No. 2011-016489 (hereinafter referred to as ‘prior art 1’) discloses a heat pipe heating device and a vehicle air conditioner using the same capable of miniaturizing the heat pipe heating device and efficiently cooling the control board.

The heat pipe heating device disclosed in in prior art 1 includes a flat PTC heater, a pair of heat pipe channels that are stacked on both sides of the PTC heater and are interconnected, a substrate holder that is integrally mounted on one side of one of the pair of heat pipe channels, and a control board provided in the substrate holder for controlling the PTC heater.

Additionally, Korean Patent Publication No. 10-2016-0082661 (hereinafter referred to as ‘prior art 2’) discloses an overheating prevention device for a battery heater that can secure stability in the battery temperature control system of an electric vehicle.

The overheating prevention device for a battery heater disclosed in prior art 2 is configured to secure stability by including a heater unit that heats a heat transfer fluid by receiving a power supply and heating a battery, a temperature-responsive switch that cuts off the power applied to the heater unit when the temperature exceeds a predetermined value (Tf), a heat transfer member that is disposed between the heater unit and the temperature-responsive switch and transfers heat from the heater unit to the temperature-responsive switch, and a fixing member that fixes one surface of the temperature-responsive switch to one surface of the heat transfer member in a resilient manner.

The prior arts 1 and 2 have the problems in that heat density concentrated on the heat lines of the heating elements increases peak current values, leading to melting, and the duty cycle required to be adjusted in pulse width modulation (PWM) becomes smaller at high voltage, causing a rapid increase in heat density.

These problems can lead to a significant decrease in the durability and stability of the heating element, significantly degrade the usability of the battery, including the occurrence of battery fires.

### DISCLOSURE

### Technical Problem

The present invention has been conceived to solve the above problems and it is an object of the present invention to provide a driving control apparatus for a fluid heater and a control method therefor that are capable of maximizing the allowable voltage range while simultaneously ensuring the stability of the fluid heater in consideration of peak current limit, maximum heater heating amount limit, and allowable maximum watt density by controlling a plurality of switching units in one of three switching modes, which have different connection configurations between the power supply unit and the first and second heating elements, according to a voltage value from the power supply unit.

### Technical Solution

The present invention features the following characteristics to solve the above problems.

The present invention includes a power supply unit configured to supply power, a plurality of heating elements configured to heat fluid with the power from the power supply unit, a switching unit comprising a plurality of switches connected between the power supply unit and the plurality of heating elements to control the power, and a control unit configured to control the plurality of switches and power supply from the power supply unit, wherein the control unit controls the plurality of switches, based on the voltage value of the power supply unit, to connect the plurality of heating elements in series or parallel or to supply power to at least one selected heating element among the plurality of heating elements according to a predetermined switching mode.

Here, the plurality of heating elements includes a first heating element connected at one end to a positive terminal of the power supply unit and a second heating element connected at one end to a negative terminal of the power supply unit, the switching unit including a first switch connected between the other end of the first heating element and the negative terminal of the power supply unit, a second switch connected between the other end of the second heating element and the positive terminal of the power supply unit, and a third switch connected between the other end of the first heating element and the other end of the second heating element.

In addition, the control unit turns on the first and second switches and turns off the third switch based on the voltage value being between a lower threshold for low voltage and an upper threshold for low voltage.

In addition, the control unit turns on one of the first and second switches and turns off the other and the third switch based on the voltage value being between an upper threshold for low voltage and a lower threshold for high voltage.

Here, the control unit turns off the first and second switches and turns on the third switch based on the voltage value being between a lower threshold for high voltage and an upper threshold for high voltage.

In addition, the control unit controls, based on the voltage value being less than a lower threshold for low voltage, the power supply unit to stop supplying power and provides low-voltage warning information, and controls, based on the voltage value being greater than an upper threshold for high voltage, the power supply unit to stop supplying power and provides high-voltage warning information.

In addition, a control method of a fluid heater driving control apparatus including a power supply unit supplying power, a plurality of heating elements, a switching unit comprising a plurality of switches connected between the power supply unit and the plurality of heating elements, and a control unit controlling the plurality of switches and the power supply unit according to the present invention includes (a) measuring a voltage value of the power supply unit, (b) selecting a switching mode based on the measured voltage value, and (c) controlling the plurality of switches to connect the plurality of heating elements in series or parallel or to supply power to at least one selected heating element among the plurality of heating elements based on the selected switching mode.

Here, the plurality of heating elements includes a first heating element connected at one end to a positive terminal of the power supply unit and a second heating element connected at one end to a negative terminal of the power supply unit, the switching unit including a first switch connected between the other end of the first heating element and the negative terminal of the power supply unit, a second switch connected between the other end of the second heating element and the positive terminal of the power supply unit, and a third switch connected between the other end of the first heating element and the other end of the second heating element.

In addition, step (b) includes selecting, by the control unit, a low-voltage mode based on the voltage value of the power supply being between a lower threshold for low voltage and an upper threshold for low voltage, a mid-voltage mode based on the voltage value of the power supply being between an upper threshold for low voltage and a lower threshold for high voltage, and a high-voltage mode based on the voltage value of the power supply being between a lower threshold for high voltage and an upper threshold for high voltage.

In addition, step (c) includes turning, by the controller, on the first and second switches and turning off the third switch based on the switching mode being the low-voltage mode.

In addition, step (c) includes turning, by the controller, on one of the first and second switches and turning off the other and the third switch based on the switching mode being the mid-voltage mode, and turning, by the controller, off the first and second switches and turning on the third switch based on the switching mode being the high-voltage mode.

In addition, step (b) includes controlling the power supply unit to stop supplying power, based on the voltage value of the power supply being less than the lower threshold for low voltage, and providing low-voltage warning information, and controlling the power supply unit to stop supplying power, based on the voltage value of the power supply being greater than an upper threshold for high voltage, and providing high-voltage warning information.

### Advantageous Effects

The present invention is advantageous in terms of improving the durability of the heater by enabling the heater to operate within the maximum watt density through adjustment of peak current in such a way as to vary the resistance of the entire heating element based on the voltage supplied from the power supply unit.

The present invention is also advantageous in terms of expanding the allowable voltage range of the power supply unit by reducing the maximum watt density in such a way as to increase heat generation in response to the voltage from the power supply unit falling within the low-voltage range and conversely decreasing the peak current in response to the voltage falling within the high-voltage range.

### DESCRIPTION OF DRAWINGS

FIG. 1 is a schematic diagram illustrating a driving control apparatus for a fluid heater according to an embodiment of the present invention;

FIG. 2 is a schematic diagram illustrating heating elements according to an embodiment of the present invention;

FIG. 3 is a schematic diagram illustrating a driving control circuit for a fluid heater according to an embodiment of the present invention;

FIG. 4 is a diagram illustrating a circuit for a low-voltage mode according to an embodiment of the present invention;

FIG. 5 is a diagram illustrating a circuit for a mid-voltage mode according to an embodiment of the present invention;

FIG. 6 is a diagram illustrating a circuit for a high-voltage mode according to an embodiment of the present invention;

FIG. 7 is a diagram illustrating comparison circuit 1 and comparison circuit 2 representing driving control circuits for conventional fluid heaters;

FIG. 8 is a graph representing resistances of a driving control circuit of the fluid heater according to an embodiment of the present invention and comparison circuits 1 and 2 across applied voltage ranges;

FIG. 9 is a graph representing peak currents of a driving control circuit of the fluid heater according to an embodiment of the present invention and comparison circuits 1 and 2 across applied voltage ranges;

FIG. 10 is a graph representing maximum heat generations of a driving control circuit of the fluid heater according to an embodiment of the present invention and comparison circuits 1 and 2 across applied voltage ranges;

FIG. 11 is a graph representing maximum watt densities of a driving control circuit of the fluid heater according to an embodiment of the present invention and comparison circuits 1 and 2 across applied voltage ranges;

FIG. 12 is a flowchart illustrating a process of a driving control method for a fluid heater according to an embodiment of the present invention; and

FIG. 13 is a flowchart illustrating the details of the processes of steps S200 and S300 in FIG. 12.

### MODE FOR INVENTION

To explain the present invention, and operational advantages and objectives to be achieved by the implementation of the present invention, preferred embodiments of the present invention are provided with description hereinbelow.

The terminology used in this application is solely employed to describe specific embodiments, with no intention to limit the scope of the present invention, and singular expressions may include plural expressions unless contextually indicating otherwise. In this application, terms such as “comprising” or “having” indicate the presence of the features, numbers, steps, operations, components, or parts listed in the specification, without excluding the presence or possibility of one or more other features, numbers, steps, operations, components, or parts or their combinations.

In explaining the present invention, detailed descriptions of well-known configurations or functions may be omitted to avoided obscuring the subject matter of the invention.

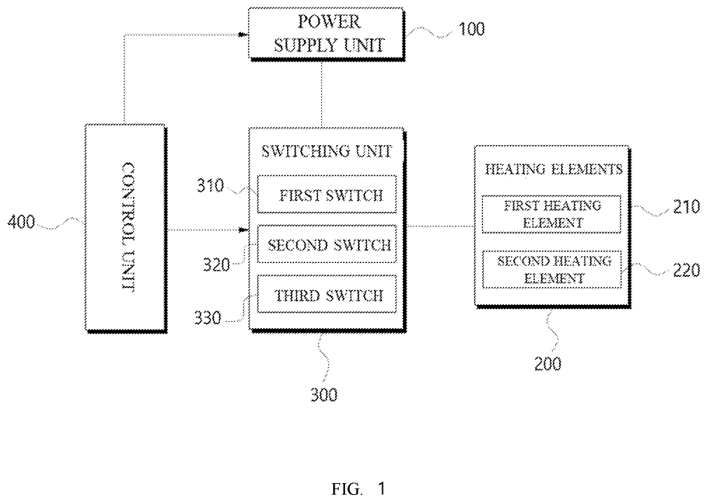

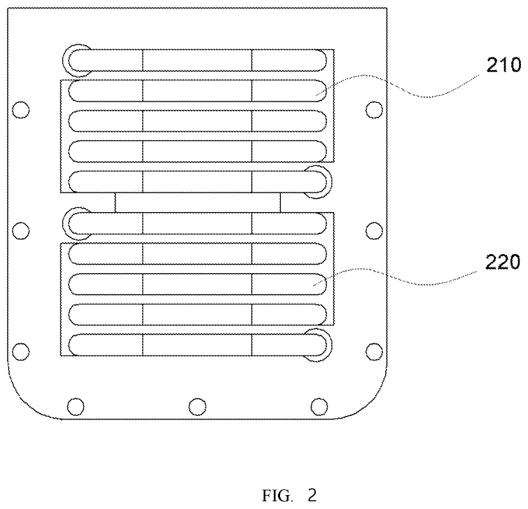

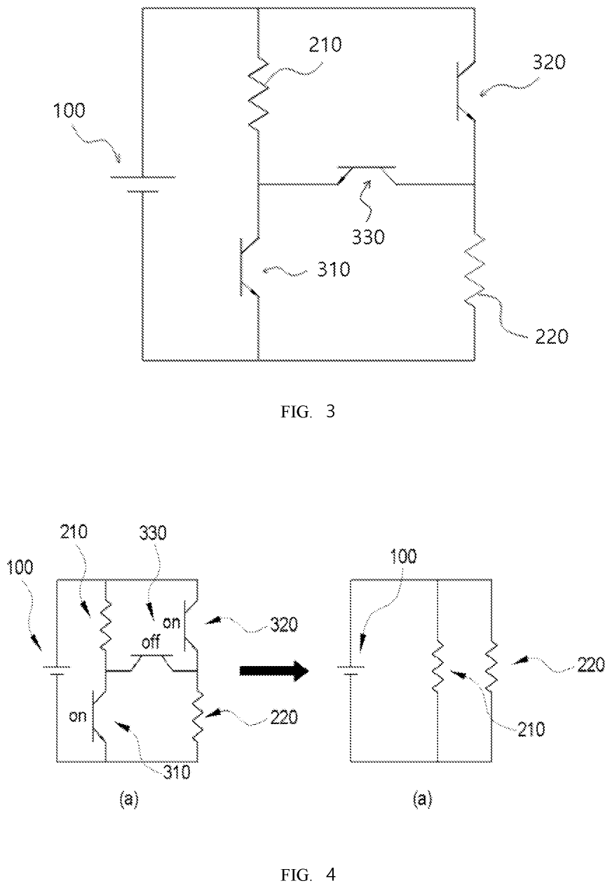

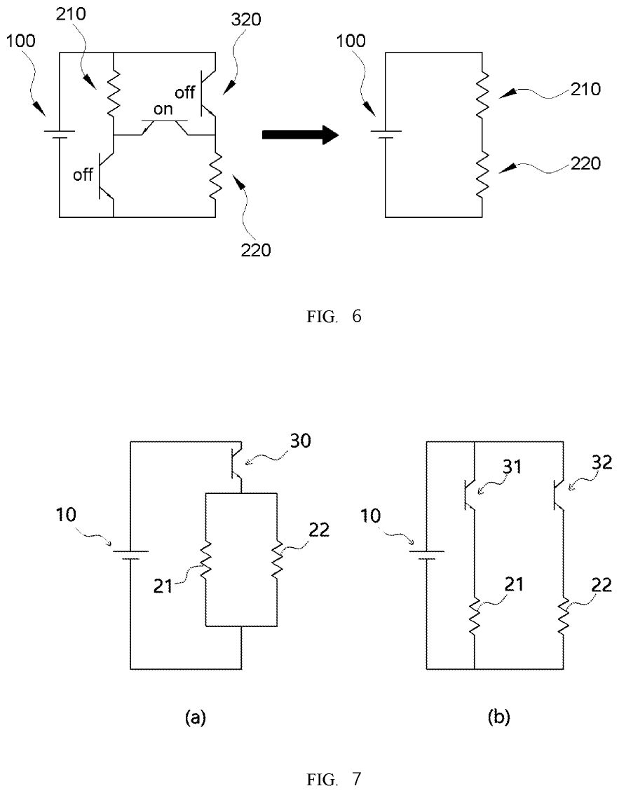

FIG. 1 is a schematic diagram illustrating a driving control apparatus for a fluid heater according to an embodiment of the present invention, FIG. 2 is a schematic diagram illustrating heating elements according to an embodiment of the present invention, FIG. 3 is a schematic diagram illustrating a driving control circuit for a fluid heater according to an embodiment of the present invention, and FIGS. 4 to 6 are diagrams illustrating circuits for each switching mode according to an embodiment of the present invention.

With reference to the drawings, the driving control apparatus for a fluid heater according to an embodiment of the present invention includes a power supply unit 100 supplying power, a plurality of heating elements 200 receiving power from the power supply unit 100 to supply thermal energy to a fluid, a switching unit 300 connected between the power supply unit 100 and the plurality of heating elements 200 to control the power supply, and a control unit 400 controlling the plurality of switches and power supply of the power supply unit, wherein the control unit 400 controls, based on the voltage value V_{dc} of the power supply unit 100, the plurality of switches to connect the plurality of heating elements 200 in series or parallel to supply power to at least one selected heating element among the plurality of heating elements 200 in a preset switching mode.

Here, the power supply unit 100 is designed to supply power to the plurality of heating elements 200 for heat generation and preferably, while a separate power supply unit is possible, configured to receive power from a battery.

In addition, the plurality of heating elements 200 is configured to receive power through the power supply unit 100 and transfer heat to a fluid serving as a heat transfer medium surrounding the heating elements 200, and according to an embodiment of the present invention, the plurality of heating elements 200 includes a first heating element 210 and a second heating element 220 spaced apart from each other.

While the configuration includes the first heating element 210 and the second heating element 220 in this embodiment of the present invention, it is possible to configure it with a third heating element or more, if necessary.

In addition, the switching unit 300 is configured to control the supply of power between the power supply unit 100 and the plurality of heating elements 200, i.e., the first heating element 210 and the second heating element 220, and in an embodiment of the present invention, the switching unit 300 includes a first switch 310 connected between one end of the first heating element 210 and the negative terminal of the power supply unit 100, a second switch 320 connected between one end of the first heating element 210 and one end of the second heating element 220, and a third switch 330 connected between the other end of the first heating element 210 and one end of the second heating element 220.

The switching unit 300 is configured with three switches because the plurality of heating elements 200 are two; however, when plurality of heating elements 200 are three, it is desirable for the switching unit 300 to be configured with six or more switches. Meanwhile, the control unit 400 controls the first, second, and third switches 310, 320, and 330 to selectively configure the power supply to the first and second heating elements 210 and 220.

The control unit 400 performs control of the switching unit 300 based on the voltage value V_{dc} of the power supply unit 100 according to a preset switching mode during the control of the switching unit 300.

Here, the voltage value V_{dc} of the power supply unit 100 may be measured by a measuring unit inside of the control unit 400 or a separate voltage measuring device configured to transmit the measurement to the control unit 400.

In addition, the preset switching modes are classified into three main modes: low-voltage mode, mid-voltage mode, and high-voltage mode.

In an embodiment of the present invention, the driving control of the fluid heater is performed through two heating elements 200 and the switching unit 300 with three switches, and the control unit manages these three switches to establish either a serial or parallel connection between the two heating elements 200 or a connection from either of the two heating elements to the power supply unit 100.

The reason for configuring the connection differently between the first and second heating elements 210 and 220 is to satisfy the heat generation and durability of the heater corresponding to the voltage value V_{dc} applied through the power supply unit 100.

That is, when the voltage value V_{dc} is high, the resistance value of the heating element, which acts as a resistive element, should be set high to prevent an increase in peak current, which could lead to increased fatigue and damage to the heating element; on the other hand, when the voltage value V_{dc} is low, it is necessary to increase the number of heating elements to compensate for the reduced heat generation caused by the lower peak current, making it difficult to efficiently heat the fluid.

Of course, even when increasing the number of heating elements, connection in series between the heating element tends to decrease the peak current, making it difficult to expect a significant increase in the overall heat generation, which means that increasing the number of heating elements should involve connecting in parallel between the heating elements to achieve an overall increase in heat generation.

In this way, the configuration of establishing the connection between the two heating elements in series or parallel or supplying power to only one of the heating elements based on the voltage value V_{dc} allows for the maintenance of a certain level of heat generation and ensures the durability of the heating elements under both high and low voltage conditions.

Therefore, in an embodiment of the present invention, the control unit 400 adjusts the connection configuration of the first and second heating elements 210 and 220 through the control of the three switches 310, 320, and 330 based on three switching modes of high-voltage mode, mid-voltage mode, and low-voltage mode, which respectively correspond to serial connection, single heating element selected connection, and parallel connection, allowing for maintaining a certain level of heat generation while ensuring the durability of the heating elements.

This makes it possible to widen the voltage range applicable to the driving control circuit of the fluid heater according to an embodiment of the present invention, enabling the use of various power sources.

Among the three switching modes determined by the measured voltage value V_{dc}, the control unit 400 determines the low-voltage mode, when the measured voltage value falls between a predetermined lower threshold for low voltage V_{ref1} and a predetermined upper threshold for low voltage V_{ref2}, to turn on the first and second switches 310 and 320 and turn off the third switch 330, allowing the first and second heating elements 210 and 220 to be connected in parallel with the power supply unit 100, as shown in FIG. 4.

In the low-voltage mode, connecting the first and second heating elements 210 and 220 in parallel helps reduce the peak current during low voltage conditions, thereby minimizing the problem of reduced heat generation.

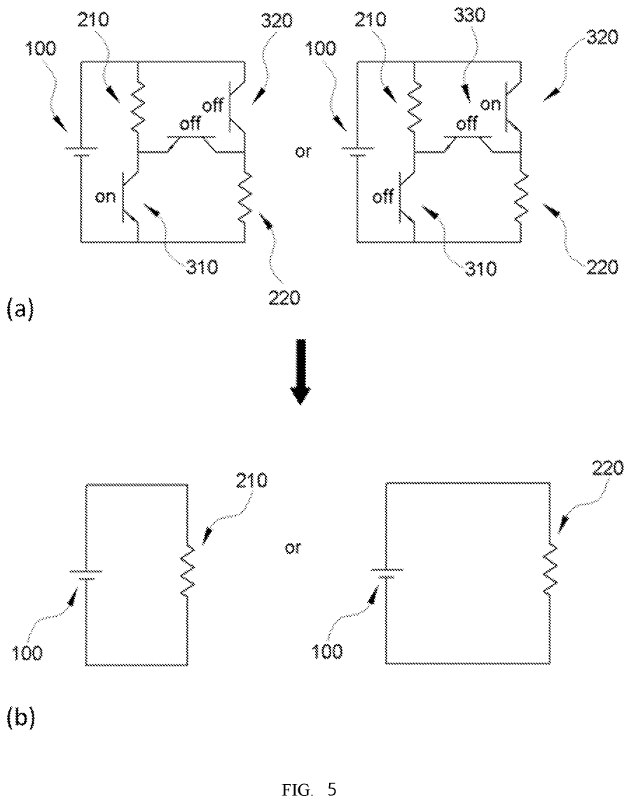

In addition, when the measured voltage value V_{dc} falls between the predetermined upper threshold for low voltage V_{ref2} and a predetermined lower threshold for high voltage (V_{ref3}), the control unit 400 determines the mid-voltage mode to turn on one of the first and second switches 310 and 320 and turn off the third switch 330, allowing only one of the first and second heating elements 210 and 220 to be connected to the power supply unit 110, as shown in FIG. 5.

Depending on configuration, it is possible to control the first and second switches 310 and 320 to be alternately on and off such that the first and second heating elements 210 and 220 are alternately connected to the power supply unit 100.

In addition, when the measured voltage value V_{dc} falls between the predetermined lower threshold for high voltage V_{ref3} and a predetermined upper threshold for high voltage V_{ref4}, the control unit 400 determines the high-voltage mode to turn off the first and second switches 310 and 320 and turn on the third switch 330, allowing the first and second heating elements 210 and 220 to be connected in series with the power supply unit 100.

Meanwhile, in an embodiment of the present invention, when the voltage value V_{dc} is less than the lower threshold for low voltage V_{ref1} or greater than the upper threshold for high voltage V_{ref4}, the control unit 400 controls the power supply unit 100 to stop supplying power.

In addition, low-voltage warning information or high-voltage warning information may be generated, as needed, to be output through a separate output device. Here, the output device may include a display device that displays warning data or an audio output device that produces alert sounds.

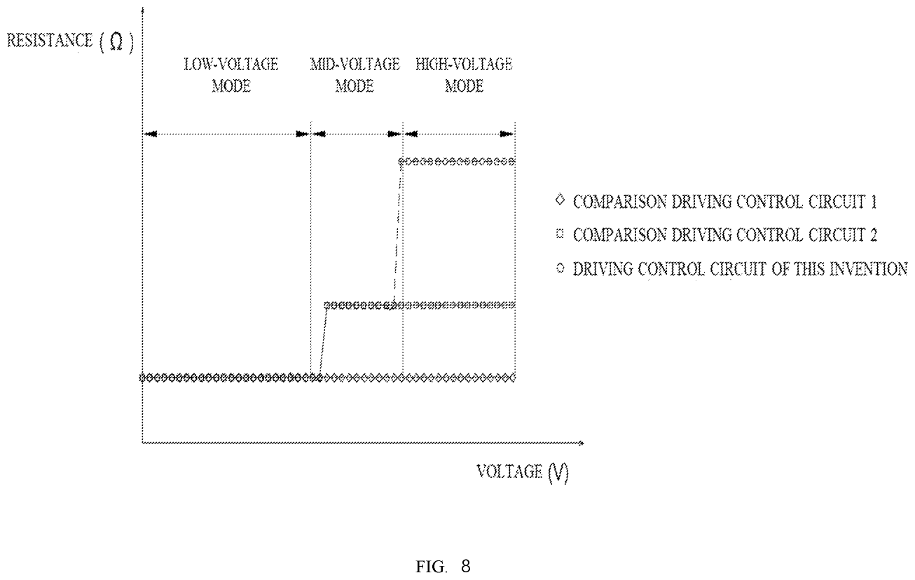

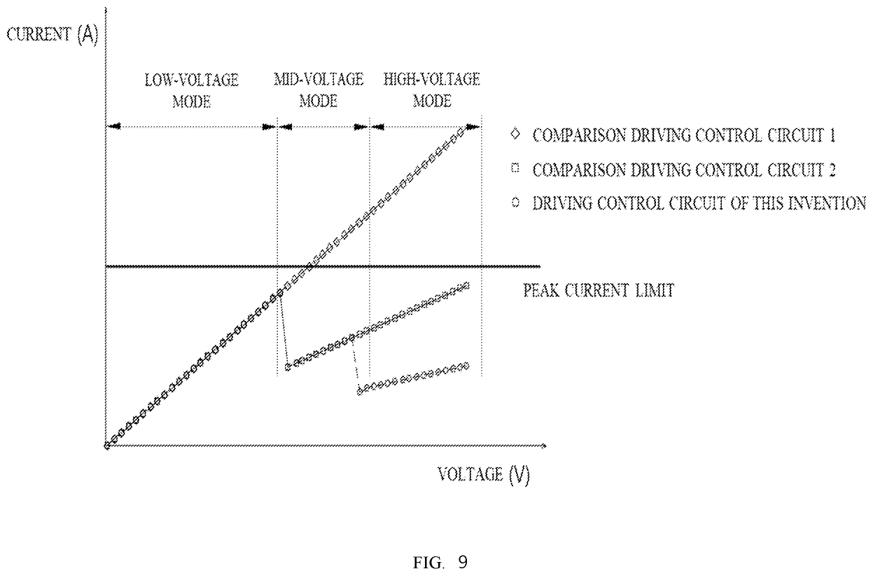

FIG. 7 is a diagram illustrating comparison circuit 1 and comparison circuit 2 representing driving control circuits for conventional fluid heaters, FIG. 8 is a graph representing resistances of a driving control circuit of the fluid heater according to an embodiment of the present invention and comparison circuits 1 and 2 across applied voltage ranges, and FIG. 9 is a graph representing peak currents of a driving control circuit of the fluid heater according to an embodiment of the present invention and comparison circuits 1 and 2 across applied voltage ranges.

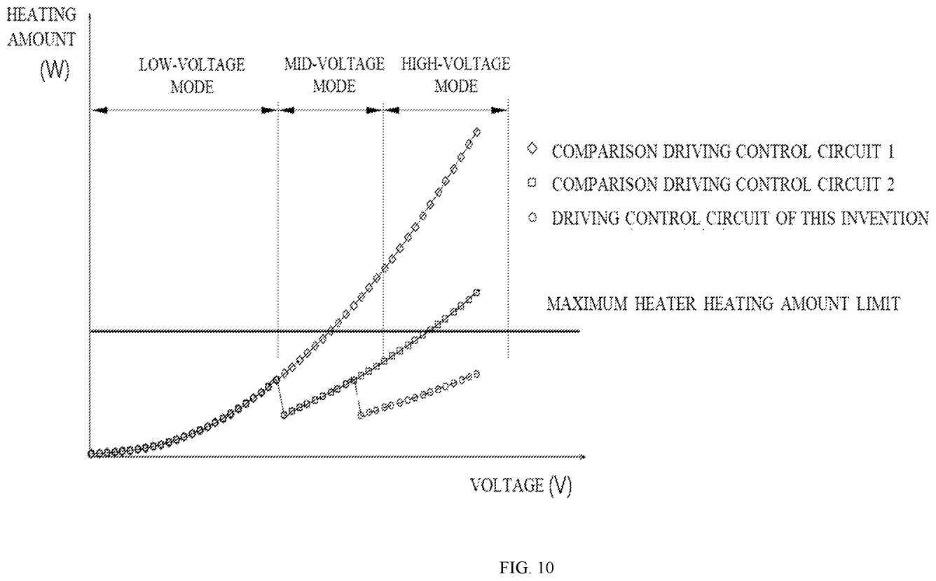

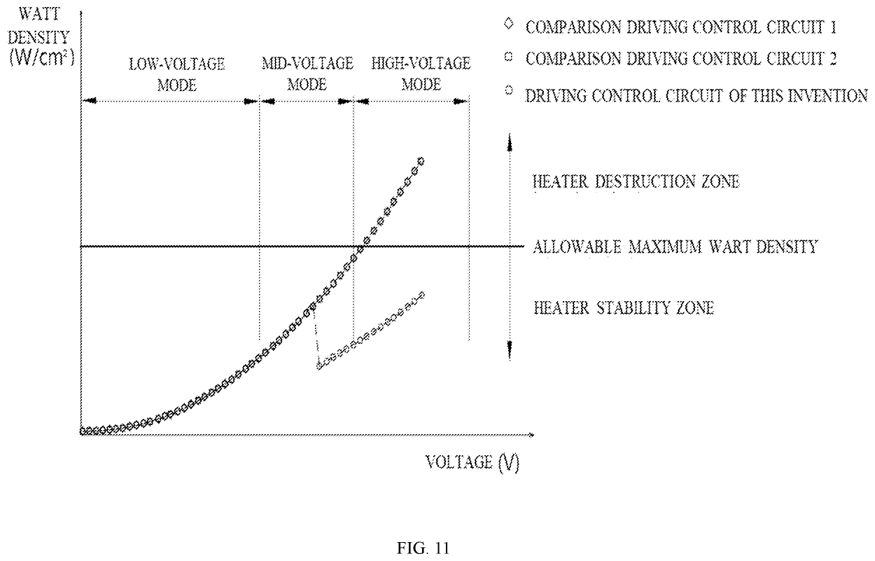

In addition, FIG. 10 is a graph representing maximum heat generations of a driving control circuit of the fluid heater according to an embodiment of the present invention and comparison circuits 1 and 2 across applied voltage ranges, and FIG. 11 is a graph representing maximum watt densities of a driving control circuit of the fluid heater according to an embodiment of the present invention and comparison circuits 1 and 2 across applied voltage ranges.

With reference to the drawings, the driving control circuit of the fluid heater according to an embodiment of the present invention is configured with the first and second heating elements 210 and 220 that are connected in parallel or in series or only one of the two heating elements is connected, as shown in FIGS. 4 to 6, unlike the conventional driving control circuits for fluid heaters that are typically configured as comparison circuit 1 or comparison circuit 2, as shown in FIG. 7.

Comparison circuit 1 corresponds to (a) in FIG. 5 and consists of one switching component 30, and a first heating element 21, and a second heating element 22, while comparison circuit 2 corresponds to (b) in FIG. 5 and consists of a first switch 31, a second switch 32, a first heating element 21, and a second heating element 22.

In the case of comparison circuit 1 where two heating elements 21 and 22 are connected in parallel, it can operate stably in the low-voltage mode; however, in the mid-voltage or high-voltage mode, the peak current may increase, leading to a reduction in durability.

In the case of comparison circuit 2, the two heating elements 21 and 22 are controlled by the first switch 31 and the second switch 32 so as to be connected in parallel or either one of the heating elements receive power.

Certainly, when only one heating element receives power, the heating elements may be configured to receive power alternately.

Comparison circuit 2 can operate stably in the low-voltage or mid-voltage modes; however, in the high-voltage mode, there may be an issue of increased heat generation for the heating elements 21 and 22, exceeding the allowable maximum watt density limit required for ensuring stable durability of the heating elements.

This is shown in FIGS. 8 to 11, where FIG. 8 shows the total resistances of the heating elements in the driving control circuits in comparison circuits 1 and 2 and the present invention, demonstrating that the total resistance of the heating element increases stepwise by varying the connection configuration between the heating elements for each switching mode.

Contrastingly, comparison circuit 1 maintains a constant total resistance, while comparison circuit 2 has two distinct total resistance values.

Accordingly, as shown in FIG. 9, the driving control circuit of the present invention is configured to vary the switching mode based on the voltage value, ensuring that the peak current remains consistently below the limit regardless of the voltage value, while comparison circuit 1 exceeds the peak current limit when the voltage value corresponds to the mid-voltage mode or high-voltage mode.

In the case of comparison circuit 2, the peak current is maintained below the limit, similar to the present invention, but it can be observed that the peak current is relatively higher in the high-voltage mode compared to the present invention.

As a result, the heat generation of the heating elements exceeds the maximum heater heat generation limit in the high-voltage mode for comparison circuit 2 as shown in FIG. 10, and the maximum watt density also exceeds the allowable maximum watt density limit as shown in FIG. 11.

Therefore, as observed in FIGS. 8 to 11, the present invention demonstrates stable heat generation operation over a relatively wide range of voltage values compared to comparison circuits 1 and 2.

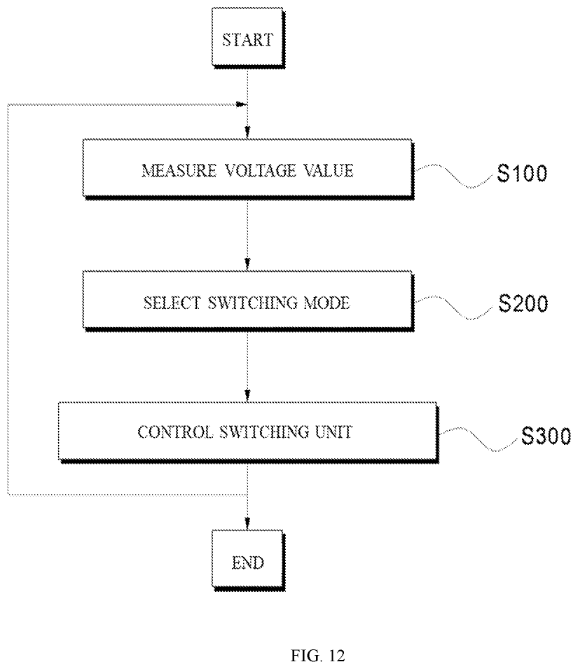

FIG. 12 is a flowchart illustrating a process of a driving control method for a fluid heater according to an embodiment of the present invention.

With reference to the drawing, the control method of a fluid heater driving control apparatus according to an embodiment of the present invention includes measuring the voltage value V_{dc} at step S100, selecting, by the control unit 400, a predetermined switching mode based on the measured voltage value V_{dc} at step S200, and controlling a plurality of switches, by the control unit 400, according to the selected switching mode to connect a plurality of heating elements 200 in series or parallel with the power supply unit 100 or to supply power to at least one selected heating element among the plurality of heating elements 200 at step S300.

Here, the power supply unit 100, the plurality of heating elements 200, and the plurality of switches are the same as those in the fluid heater driving control apparatus described above.

Therefore, the driving control method of the fluid heater according to an embodiment of the present invention includes measuring, at step S100, the voltage value V_{dc} when power is supplied by the power supply unit 100.

The voltage value may be measured by a measuring unit within the control unit 400 or by a separate voltage measuring device and transmitted to the control unit 400.

The control unit 400 selects a predetermined switching mode based on the measured voltage value V_{dc} at step S200, and the selected switching mode is one of the low-voltage mode, mid-voltage mode, and high-voltage mode as described above.

In the process for the control unit 400 to select the switching mode, the control unit 400 selects the low-voltage mode based on the received voltage value V_{dc} falling between a predetermined lower threshold for low voltage V_{ref1} and a predetermined upper threshold for low voltage V_{ref2}, the mid-voltage mode based on the received voltage value V_{dc} falling between the predetermined upper threshold for low voltage V_{ref2} and a predetermined lower threshold for high voltage V_{ref3}, and the high-voltage mode based on the received voltage value V_{dc} falling between the predetermined lower threshold for high voltage V_{ref3} and a predetermined upper threshold for high voltage V_{ref4}.

Upon selecting the switching mode, the control unit 400 performs, at step S300, on/off control of the switching unit 300, i.e., the first switch 310, the second switch 320, and the third switch 330, according to the selected switching mode.

In the process for the control unit 400 to control the switching unit 300 for each switching mode, the control unit 400 turns on the first and second switches 310 and 320 and turns off the third switch 330, based on the switching mode being the low-voltage mode, to connect the first and second heating elements 210 and 220 in parallel with the power supply unit 100.

Based on the switching mode being the mid-voltage mode, the control unit 400 turns on one of the first and second switches 310 and 320 and turns off the other and the third switch 330, ensuring that only one of the first and second heating elements 210 and 220 is connected to the power supply unit 100.

Depending on configuration, it may be possible to control the first and second switches 310 and 320 to be alternately on and off such that the first and second heating elements 210 and 220 are alternately connected to the power supply unit 100.

Based on the switching mode being the high-voltage mode, the control unit 400 turns off the first and second switches 310 and 320 and turns on the third switch 330, ensuring that the first and second heating elements 210 and 220 are connected in series with the power supply unit 100.

When the voltage value V_{dc} measured at step S200 is less than the predetermined lower threshold for low voltage V_{ref1}, the control unit 400 may control the power supply unit 100 to stop supplying power and provide low-voltage warning information to be output externally through a separate output device.

Here, the output device may be a display device that displays warning data or an audio output device that produces alert sounds.

Even when the voltage value V_{dc} is greater than the predetermined upper threshold for high voltage V_{ref4}, the control unit 400 controls the power supply unit 100 to stop supplying power and provides high-voltage warning information to be output through an output device.

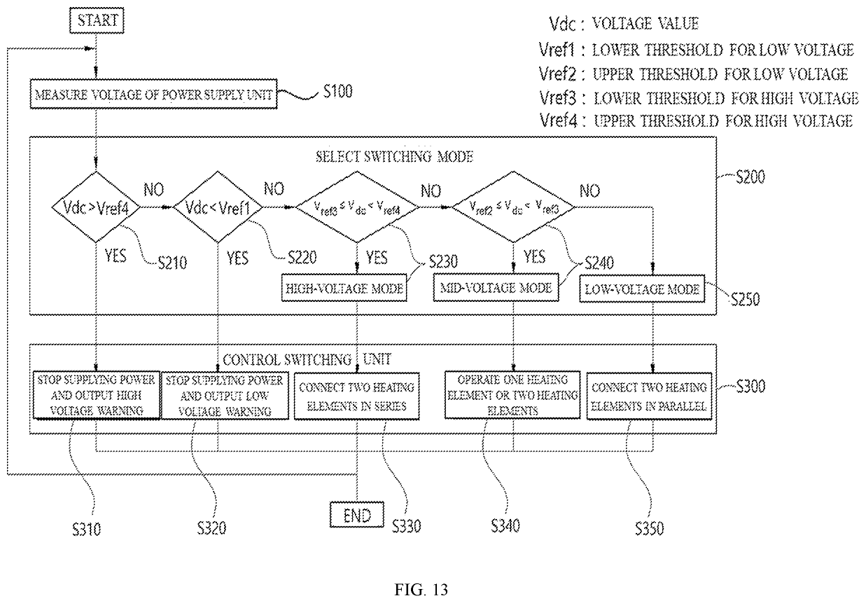

FIG. 13 is a flowchart illustrating the details of the processes of steps S200 and S300 in FIG. 12.

Hereinafter, detailed descriptions are provided for the selection of the switching mode at step S200 and the control of the switching unit 300 at step S300 in the driving control method of the fluid heater according to an embodiment of the present invention, with reference to the drawings.

According to this embodiment, in step S200, the control unit 400 first determines whether the measure voltage value V_{dc} is greater than the upper threshold for high voltage V_{ref4} at step S210, controls, when true, the power supply unit 100 to stop supplying power and provides high-voltage warning information at step S310, and when false, proceeds to determine at step S220 whether the voltage value V_{dc} is less than the lower threshold for low voltage V_{ref1}.

Here, the control unit controls the power supply unit 100 to stop supplying power and provides low-voltage warning information at step S320 when true that the voltage value V_{dc} is less than the lower threshold for low voltage V_{ref1}, and when false, determines at step S230 whether the voltage value V_{dc} is equal to or greater than the lower threshold for high voltage V_{ref3} and less than the upper threshold for high voltage V_{ref4}; when true, the control unit determines the high-voltage mode and controls the switching unit 300 to connect the first and second heating elements 210 and 220 connect in series at step S330.

When false, the control unit determines at step S240 whether the voltage value V_{dc} is equal to or greater than the upper threshold for low voltage V_{ref2} and less than the lower threshold for high voltage V_{ref3}, and when true, determines the mid-voltage mode and controls the switching unit 300 to connect either the first heating element or the second heating element to the power supply unit 100.

When false, this implies that the voltage value is equal to or greater than the lower threshold for low voltage V_{ref1} and less than the upper threshold for low voltage V_{ref2}, and in this case, the control unit determines the low-voltage mode at step S250 and controls the switching unit 300 to connect the first and second heating elements 210 and 220 in parallel at step S350.

The specific process of selecting the switching mode at step S200, may have variations in the sequence, but once a particular switching mode is determined, the subsequent process performed by the control unit 400 may not be altered.

Although the descriptions are made of the preferred embodiments of the present invention, the present invention is not limited to these embodiments. In other words, to those skilled in the art to which the present invention belongs, it will be obvious that various changes and modifications can be made to the present invention without departing from the spirit and scope of the attached claims, and all such variations and modifications are considered to be within the scope of the present invention.

1. A driving control apparatus for a fluid heater, the apparatus comprising:
a power supply unit configured to supply power; a plurality of heating elements configured to heat fluid with the power from the power supply unit;
a switching unit comprising a plurality of switches connected between the power supply unit and the plurality of heating elements to control the power; and
a control unit configured to control the plurality of switches and power supply from the power supply unit, wherein the control unit controls the plurality of switches, based on the voltage value of the power supply unit, to connect the plurality of heating elements in series or parallel or to supply power to at least one selected heating element among the plurality of heating elements according to a predetermined switching mode.

2. The apparatus of claim 1, wherein the plurality of heating elements comprises: a first heating element connected at one end to a positive terminal of the power supply unit; and a second heating element connected at one end to a negative terminal of the power supply unit, the switching unit comprising a first switch connected between the other end of the first heating element and the negative terminal of the power supply unit, a second switch connected between the other end of the second heating element and the positive terminal of the power supply unit, and a third switch connected between the other end of the first heating element and the other end of the second heating element.

3. The apparatus of claim 2, wherein the control unit turns on the first and second switches and turns off the third switch based on the voltage value of the power supply being between a lower threshold for low voltage and an upper threshold for low voltage.

4. The apparatus of claim 2, wherein the control unit turns on one of the first and second switches and turns off the other and the third switch based on the voltage value of the power supply being between an upper threshold for low voltage and a lower threshold for high voltage.

5. The apparatus of claim 2, wherein the control unit turns off the first and second switches and turns on the third switch based on the voltage value of the power supply being between a lower threshold for high voltage and an upper threshold for high voltage.

6. The apparatus of claim 2, wherein the control unit controls, based on the voltage value of the power supply being less than a lower threshold for low voltage, the power supply unit to stop supplying power and provides low-voltage warning information, and controls, based on the voltage value of the power supply being greater than an upper threshold for high voltage, the power supply unit to stop supplying power and provides high-voltage warning information.

7. A control method of a fluid heater driving control apparatus comprising a power supply unit supplying power, a plurality of heating elements, a switching unit comprising a plurality of switches connected between the power supply unit and the plurality of heating elements, and a control unit controlling the plurality of switches and the power supply unit, the method comprising:
(a) measuring a voltage value of the power supply unit;
(b) selecting a switching mode based on the measured voltage value; and
(c) controlling the plurality of switches to connect the plurality of heating elements in series or parallel or to supply power to at least one selected heating element among the plurality of heating elements based on the selected switching mode.

8. The method of claim 7, wherein the plurality of heating elements comprises: a first heating element connected at one end to a positive terminal of the power supply unit; and a second heating element connected at one end to a negative terminal of the power supply unit, the switching unit comprising a first switch connected between the other end of the first heating element and the negative terminal of the power supply unit, a second switch connected between the other end of the second heating element and the positive terminal of the power supply unit, and a third switch connected between the other end of the first heating element and the other end of the second heating element.

9. The method of claim 8, wherein Step (b) comprises selecting, by the control unit, a low-voltage mode based on the voltage value of the power supply being between a lower threshold for low voltage and an upper threshold for low voltage, a mid-voltage mode based on the voltage value of the power supply being between an upper threshold for low voltage and a lower threshold for high voltage, and a high-voltage mode based on the voltage value of the power supply being between a lower threshold for high voltage and an upper threshold for high voltage.

10. The method of claim 9, wherein step (c) comprises turning, by the controller, on the first and second switches and turning off the third switch based on the switching mode being the low-voltage mode.

11. The method of claim 9, wherein step (c) comprises turning, by the controller, on one of the first and second switches and turning off the other and the third switch based on the switching mode being the mid-voltage mode.

12. The method of claim 9, wherein step (c) comprises turning, by the controller, off the first and second switches and turning on the third switch based on the switching mode being the high-voltage mode.

13. The method of claim 9, wherein step (b) comprises controlling the power supply unit to stop supplying power, based on the voltage value of the power supply being less than the lower threshold for low voltage, and providing low-voltage warning information; and controlling the power supply unit to stop supplying power, based on the voltage value of the power supply being greater than an upper threshold for high voltage, and providing high-voltage warning information.
